(19) United States
(12) Patent Application Publication
(10) Pub. No.: US 2025/0217992 A1
(43) Pub. Date: Jul. 3, 2025

(54) SYSTEM AND METHOD FOR AUTOMATIC SEGMENTATION AND REGISTRATION OF THE CARDIAC MYOCARDIUM

(71) Applicant: The Regents of the University of California, Oakland, CA (US)

(72) Inventors: Minsong Cao, Encino, CA (US); Robert Chin, Los Angeles, CA (US); Dan Ruan, Los Angeles, CA (US); Eric Morris, St. Louis, MO (US)

(21) Appl. No.: 18/846,582

(22) PCT Filed: Mar. 14, 2023
(86) PCT No.: PCT/US2023/064345

§ 371 Date: Sep. 12, 2024

Related U.S. Application Data
(60) Provisional application No. 63/319,430, filed on Mar. 14, 2022.

(51) Int. Cl. G06T 7/11; G06T 7/149

(52) U.S. Cl. CPC G06T 7/11; G06T 7/149; G06T 2207/10081; G06T 2207/10088; G06T 2207/20036; G06T 2207/20084; G06T 2207/30048

(57) ABSTRACT

A method for segmentation of a cardiac myocardium in one or more images of a subject includes receiving at least one image of a heart of the subject, a segmentation of at least one heart structure, and an identification of a right ventricle insertion point, providing the at least one image of a heart of the subject, the segmentation of the at least one heart structure, and the identification of a right ventricle insertion point to a segmentation model, and generating, using the segmentation model, a subject specific seventeen segment myocardial contour model.

### CROSS-REFERENCE TO RELATED APPLICATIONS

This application is based on, claims priority to, and incorporates herein by reference in its entirety U.S. Ser. No. 63/319,430 filed Mar. 14, 2022 and entitled “System and Method for Automatic Segmentation and Registration of the Cardiac Myocardium.”

### BACKGROUND

Cardiac arrhythmias, including, but not limited to ventricular tachycardia (VT) and atrial fibrillation, represents one of the major life-threatening cardiac diseases in the world. For example, in the US, deaths from ventricular tachycardia are equal to the deaths from the top four cancers combined. VT may arise from coronary artery disease (CAD) (e.g. scar-related VT) or other structural cardiomyopathies (e.g. non-ischemic dilated cardiomyopathy (DCM)) and is life-threatening as it can degenerate into ventricular fibrillation (Vfib) and cardiac arrest.

Current treatments of VT involve the placement of a cardiovascular implantable electronic device (CIED) that monitors the heart's rhythm and can detect and deliver an electric shock to attempt to correct an abnormal rhythm. Antiarrhythmic drugs (AADs) and radiofrequency catheter ablation (RFA) can also significantly decrease the ventricular arrhythmia burden. However. RFA may be associated with significant procedural risks for high-risk patients and has an average success rate near 70%. Furthermore, many VT patients exhibit RFA-refractory disease and require multiple procedures.

Stereotactic body radiation therapy (SBRT) is a form of hyper-fractionated radiation therapy that makes use of image guidance to deliver focused high-dose ionizing radiation beams to a precise location in the body while minimizing dose to the surrounding healthy normal tissue. Recently, stereotactic ablative radiotherapy (SABR) has been employed as a safe and non-invasive treatment option to target the arrhythmogenic substrate for patients with VT that are refractory to AADs or not a candidate for RFA. The contra-indications for RFA can include single peripheral lesions of five cm or greater, more than three lesions where any are greater than three cm, Class C Child-Turcotte-Pugh patients (i.e. decompensated disease), and patients who are poor surgical candidates due to multiple comorbidities etc. Additionally, numerous recent studies have employed SABR treatments for non-invasive radio-ablation for arrhythmias, cardiac fibromas, and other cardiac indications. In one prior study, the treatment of VT in single fraction of 25 Gy using SABR for 5 patients resulted in a significant reduction in total cardiac episodes. Overall, the use of SABR for cardiac ablation of VT has shown favorable outcomes for patients with limited alternative options.

Although SABR has been presented as a promising treatment alternative to conventional therapies for VT, defining the treatment target in this setting remains challenging because of the difficulties in integrating electrophysiological information (e.g. 12-lead surface ECG and electro-anatomic mapping (EAM)) to radiation treatment planning images The issues with defining the target are a significant obstacle to the much wider utilization of SBRT or SABR. One promising approach to address the challenges of defining a target has been to define the target using the American Heart Association (AHA) standard 17-segment contour model. The 17-segment model from the AHA has anatomical basis, the segments can be reasonably identified using echocardiographic landmarks, and has been used and validated in several multicenter cooperative studies. However, defining these 17-segment contours manually on, for example, a radiation therapy treatment planning computed tomography (CT) dataset can be as difficult, time-consuming, and error-prone with large inter-observer variability as defining the target itself.

It would be desirable to provide a system and method for automatically segmenting or generating the 17-segment contours on images for radiation therapy that is reliable and consistent.

### SUMMARY

In accordance with an embodiment, a method for segmentation of a cardiac myocardium in one or more images of a subject includes receiving at least one image of a heart of the subject, a segmentation of at least one heart structure, and an identification of a right ventricle insertion point, providing the at least one image of a heart of the subject, the segmentation of the at least one heart structure, and the identification of a right ventricle insertion point to a segmentation model, and generating, using the segmentation model, a subject specific seventeen segment myocardial contour model.

In accordance with another embodiment. a system for segmentation of a cardiac myocardium in one or more images of a subject includes an input configured to receive at least one image of a heart of the subject, a segmentation of at least one heart structure, and an identification of a right ventricle insertion point. and a segmentation model coupled to the input and configured to generate a subject specific seventeen segment myocardial contour model based on the at least one image of a heart of the subject, the segmentation of at least one heart structure, and the identification of a right ventricle insertion point. The system can further include a post-processing module coupled to the segmentation model and configured to perform morphological closing on the subject specific seventeen segment contour model.

### BRIEF DESCRIPTION OF THE DRAWINGS

The present invention will hereafter be described with reference to the accompanying drawings, wherein like reference numerals denote like elements.

FIG. 1 illustrates an example segmentation of the left ventricle into seventeen segments in accordance with an embodiment:

FIG. 2 is a block diagram of a system for segmentation of a cardiac myocardium in one or more images of a subject in accordance with an embodiment:

FIG. 3 illustrates a method for segmentation of a cardiac myocardium in one or more images of a subject in accordance with an embodiment;

FIGS. 4A-4C illustrates example inputs for a segmentation model for segmenting a cardiac myocardium in accordance with an embodiment;

FIG. 5 illustrates an example automatically identified parasternal long axis and automatically derived points used to define three parasternal short axis in accordance with an embodiment:

FIG. 6 illustrates example vectors used to identify planes used for basal and mid-cavitary regions of a left ventricle in accordance with an embodiment;

FIG. 7 illustrates example points used to identify an apical region of a left ventricle in accordance with an embodiment:

FIG. 8 illustrates an example of identified regions for cardiac segments in accordance with an embodiment:

FIG. 9A shows an example segmentation of a left ventricle including seventeen segments in accordance with an embodiment:

FIG. 9B shows the example segmentation of a left ventricle of FIG. 9A after post processing in accordance with an embodiment; and

FIG. 10 is a block diagram of an example computer system in accordance with an embodiment.

### DETAILED DESCRIPTION

The present disclosure describes a system and method for automatic segmentation and registration of the cardiac myocardium in images of a subject. In some embodiments, the segmentation of the cardiac myocardium may be used for targeted localization of cardiac arrhythmias in radiotherapy.

In some embodiments, the automated segmentation of the cardiac myocardium may be used to facilitate the target delineation for treatment (e.g., SBRT, SABR) of VT. The automatic segmentation of the cardiac myocardium may be performed using a segmentation model configured to automatically generate a patient specific 17-segment myocardial contour model. In some embodiments. one or more operations of the segmentation model may be implemented using artificial intelligence (i.e., deep learning neural network(s)). The segmentation model may utilize a plurality of inputs including at least one image of the heart of the subject, a segmentation of at least one heart structure (e.g., the left ventricle (LV) structure or the myocardial wall structure), and at least one anatomical landmark (e.g., a right ventricle insertion point). The images of the heart of the subject may be acquired using an imaging modality which has three dimensional information of cardiac anatomy such as, for example, computed tomography (CT), magnetic resonance imaging (MRI), PET/CT, or SPECT/CT. For example, the image(s) input to the segmentation model may be, for example, planning CT images or cardiac late gadolinium enhancement magnetic resonance images. In some embodiments, the input segmentation of the one or more heart structures (e.g.,the left ventricular (LV) structure. the myocardial wall structure) may be automatically generated from images of the heart of a subject (e.g., the images used as an input into the segmentation model for generating the 17-segment myocardial contour model) using a known artificial intelligence (i.e., deep learning neural network) based technique. In some embodiments, the segmentation of the one or more heart structures (e.g., the LV structure, the myocardial wall structure) may be performed manually on images of the heart of the subject (e.g., the images used as an input into the segmentation model for generating the 17-segment myocardial contour model). In some embodiments, as discussed further below, a user may select an image of the heart of the subject 204 and the at least one anatomical landmark (e.g., a right ventricle insertion point) may be manually identified by a user (e.g., a physician or operator) on the selected image. Based on the inputs provided to the segmentation model, (e.g., image(s) of the heart of the subject, the LV structure or myocardial wall structure segmentation, and anatomic landmark(s) identified by the user), a patient specific 17-segment myocardial contour model may be automatically generated using the segmentation model. In some embodiments, a 17-segment myocardial contour model is generated according to the American Heart Association (AHA) standard. The automatically generated patient specific 17-segment contour model can be used, for example, to localize the substrate targets obtained from electrophysiological systems to generate a final planning target volume for radiation therapy (e.g., SBRT, SABR). In some embodiments, the segmentation model can be used to generate a 17-segment myocardial contour model based on CT images of the subject and MR images of the subject and the identified segments (i.e., of the seventeen segment myocardial contour model) on the CT and MRI images, respectively, can be used to guide image registration between these image modalities for refining the planning target volume.

The described segmentation and registration system and method can remove the most significant technical barrier to the wide adoption of radiation therapy (e.g., SBRT, SABR) for treatment of cardiac arrythmias by advantageously allowing clear and reliable identification of the target zone even by novice practitioners. In some embodiments, the system and methods for automatic segmentation of the cardiac myocardium, which may also be referred to as the ASSET model (Auto-segmentation of the Seventeen SEgments for Tachycardia ablation). may advantageously be used to aid physicians, physicists, and cardiologists in radiation therapy planning. As discussed further below, in some embodiments, the disclosed system and methods for automatic segmentation of the cardiac myocardium can take less than 5 minutes to run and can require only one physician defined point.

Advantageously. in some embodiments the disclosed system and methods for automatic segmentation of the cardiac myocardium offers efficient and reliable automatic segmentations for the 17 segments of the left ventricle myocardium (LVM) on images of a subject (for example, non-contrast CT) for radiation therapy planning. In some embodiments, the disclosed automatic segmentation model (or tool) can be easily implemented into clinical practice to facilitate target delineation for radiation therapy (e.g., SBRT, SABR) treatment of VT. In some embodiments, once the right ventricle (RV) insertion point (or other anatomical landmark) and the left ventricle (or other heart structure such as the myocardium wall) are defined (e.g., manually defined by a physician) on the, for example, planning computer tomography (CT) images, a patient specific 17-segment myocardial contour model can be automatically generated according to the American Heart Association (AHA) standard using the disclosed segmentation model based on the CT planning image, the RV insertion point, and the LV. In some embodiments the disclosed segmentation model can generate a patient specific 17-segment contour model that localizes the substrate targets obtained from electrophysiological systems to generate a final planning target volume for radiation therapy.

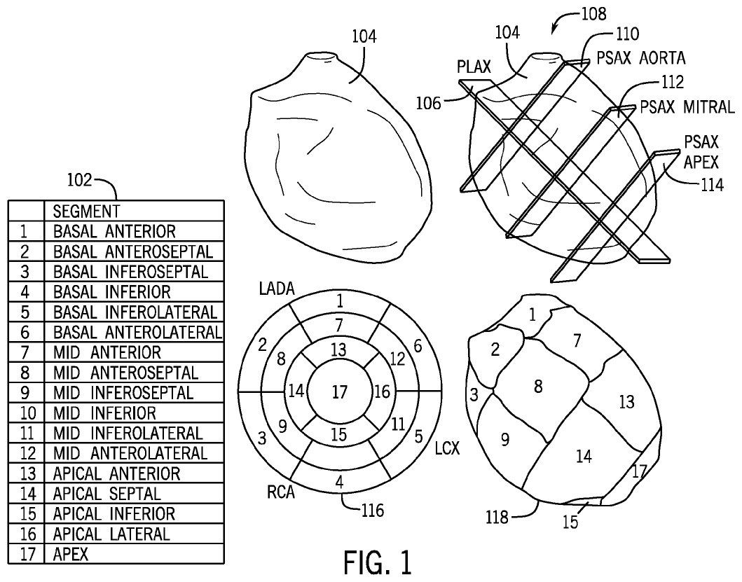

As mentioned above, the disclosed segmentation model (or ASSET model) may be configured to generate a patient specific 17-segment myocardial contour model according to the American Heart Association (AHA) standard. FIG. 1 illustrates an example segmentation of the left ventricle into seventeen segments in accordance with an embodiment. The AHA recommends that the LV can be divided into 17 individual segments as it allows for precise localization and provides an adequate sampling of the coronary distribution. Additionally, having a standardized and consistent model optimizes both the inter-and intra-modality evaluations that may be completed for diagnosis and treatment planning. In some embodiments, the definitions of the 17 segments of the LV follow published consensus guidelines.

FIG. 1 shown an example segmentation of the left ventricle 104. To define the 17 segments according to the AHA standard, the LV 104 can be split into four regions (i.e. the apex, apical, mid (or mid-cavitary), and basal regions) using three planes along the parasternal short-axis (PSAX) shown in the upper right diagram 108. The three parasternal short axis (PSAX) planes can include the PSAX aorta 110, the PSAX mitral 112, and the PSAX apex 114 as shown in FIG. 1. The parasternal long-axis (PLAX) 106 is the plane through the longest section of the left ventricle 104 and where the primary principal component goes through. Not considering the apex of the heart, the three parasternal short axis planes 110, 112, 114 can be used to define the apical, mid, and basal regions as three equal regions of equivalent lengths along the axis of the heart (i.e., the PLAX 106). Further, the mid and basal regions can be subdivided into six segments of 60° each and the apical region can be subdivided into four segments of 90° each. The wall segments can be defined based upon internal anatomical landmarks with standard myocardium thickness or patient specific myocardial wall segmentation, yielding the 17 segments according to the AHA standard which are listed in the table 102 in FIG. 1 and include, the basal anterior, the basal anteroseptal, the basal inferoseptal, the basal inferior, the basal inferolateral, the basal anterolateral, the mid anterior, the mid anteroseptal, the mid inferoseptal, the mid inferior, the mid inferolateral. the mid anterolateral, the apical anterior, the apical septal, the apical inferior, the apical lateral and the apex.

In the bottom left of FIG. 1, the American Heart Association bulls eye 116 is shown displaying how segments (listed in table 102) of the LV 104 can be split between three coronary artery territories including the left anterior descending artery (LADA), the right coronary artery (RCA), and the left circumflex coronary artery (LCX). The bottom right of FIG. 1, shows a display 118 of the left ventricle split into 17 segments (listed in table 102) based on 17 segment American Heart Association model. It is noted that not all of the seventeen segments are shown in the display 118.

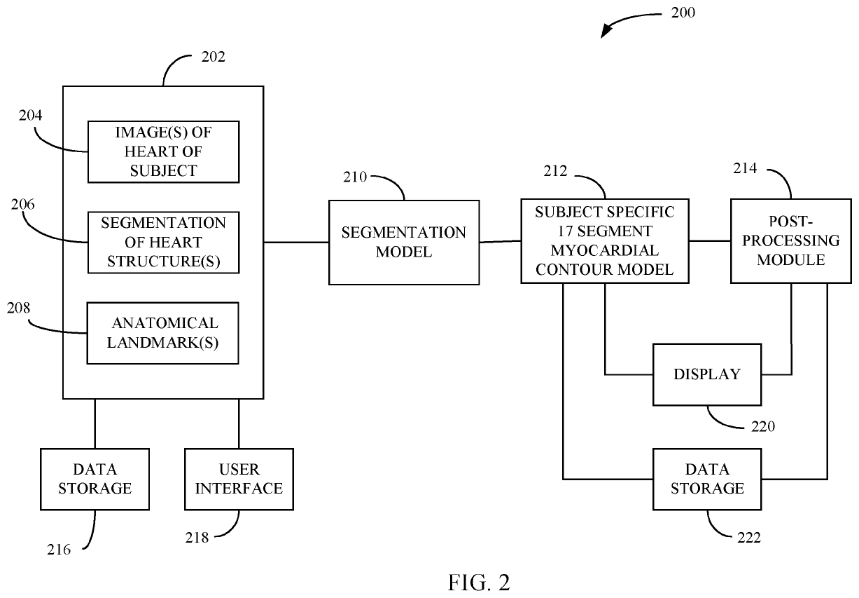

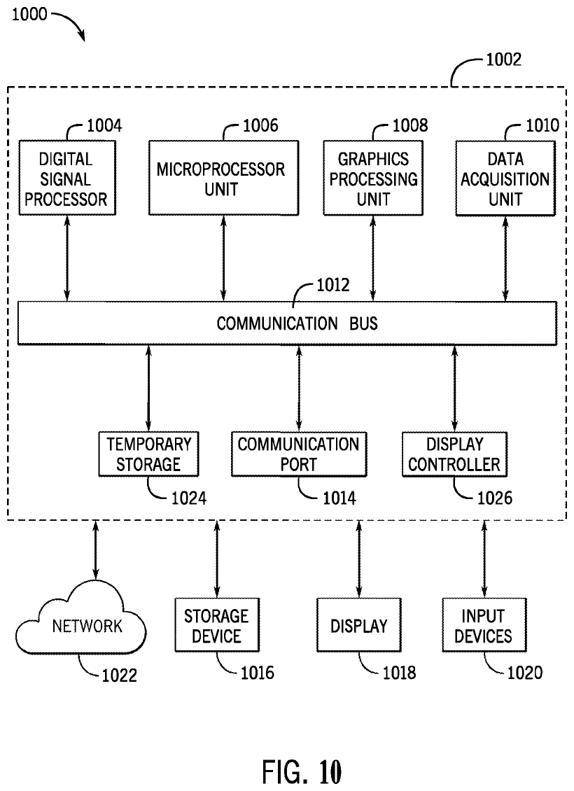

FIG. 2 is a block diagram of a system for segmentation of a cardiac myocardium in one or more images of a subject in accordance with an embodiment. System 200 can include a plurality of inputs 202, a segmentation model 210. an output 212 of the segmentation model, a post-processing module 214, data storage 216, 222, a user interface 218, and a display 220. In some embodiments, the plurality of inputs 202 can include one or more images 204 of a heart of a subject, a segmentation of at least one heat structure 206, and at least one anatomical landmark 208. The images of the heart 204 of the subject may be. for example, acquired using an imaging modality which has three dimensional information of cardiac anatomy such as, for example, computed tomography (CT), magnetic resonance imaging (MRI), PET/CT, or SPECT/CT. The images of the heart 204 may be acquired using known imaging systems such as, for example, a CT system or an MRI system, and known acquisition techniques. For example, the image(s) input to the segmentation model may be, for example, planning CT images or cardiac late gadolinium enhancement magnetic resonance images. In some embodiments, the input segmentation of the one or more heart structures 206 (e.g., the left ventricular (LV) structure, the myocardial wall structure) may be automatically generated from images of the heart of a subject (e.g., the images used as an input into the segmentation model for generating the 17-segment myocardial contour model) using a known artificial intelligence (i.e., deep learning neural network) based technique. In some embodiments, the segmentation of the one or more heart structures 206 (e.g., the LV structure, the myocardial wall structure) may be performed manually on images of the heart of the subject (e.g., the images used as an input into the segmentation model for generating the 17-segment myocardial contour model). In some embodiments, the at least one anatomical landmark 208 (e.g., a right ventricle insertion point) may be manually identified by a user (e.g., a physician or operator) on a selected image of the heart of the subject using, for example, a user interface 218. The user interface 218 may include one or more input devices such as, for example, a keyboard, a mouse, a touch screen, etc. In some embodiments, one or more of the inputs 202 can be retrieved from data storage (or memory) 216 of system 200, data storage of an imaging system (e.g., a CT system, an MRI system), or data storage of other computer systems (e.g., storage device 1016 of computer system 1000 shown in FIG. 10).

The inputs 202 may be provided to the segmentation model 210. The segmentation model 210 may be configured to automatically generate an output 212 including a subject specific seventeen segment myocardial contour for a subject based on the inputs 202. In some embodiments, one or more operations of the segmentation model may be implemented using artificial intelligence (i.e., deep learning neural network(s)). For example, a neural network may be configured to perform principal component analysis (PCA) to automatically identify or generate a parasternal long axis (PLAX) for the segmentation process of the segmentation model 210. In some embodiments, a neural network for the segmentation model can be trained using known training methods. As mentioned above, the subject specific seventeen segment myocardial contour model 212 generated by the segmentation model 210 can include the seventeen segments of the LV as defined by the AHA standard. In some embodiments, the subject specific seventeen segment myocardial contour model output 212 may be displayed on a display 220. In some embodiments, the subject specific seventeen segment myocardial contour model output 212 may also be stored in data storage, for example, data storage 222 (e.g., device storage 1016 of computer system 1000 shown in FIG. 10.

As mentioned, the segmentation model 210 may be configured to generate an output 212, for example, a subject specific seventeen segment myocardial contour model, that may be provided to the post-processing model 214. The post-processing module 214 may be configured to perform. for example. morphological closing on the output 212 seventeen segments generated by the segmentation model 210. The output of the post-processing module 214 may be displayed on a display 220. In some embodiments. the output of the post-processing module 214 may also be stored in data storage, for example, data storage 222 (e.g., device storage 1016 of computer system 1000 shown in FIG. 10.

In some embodiments, the segmentation model 210, and the post-processing module 214 may be implemented on one or more processors (or processor devices) of a computer system such as, for example, any general purpose computing system or device such as a personal computer, workstation, cellular phone, smartphone, laptop, tablet, or the like. As such, the computer system may include any suitable hardware and component designed or capable of carrying out a variety of processing and control tasks, including, but not limited to, steps for receiving inputs 202 (e.g., one or more images 204 of a heart of a subject. a segmentation of at least one heat structure 206, and at least one anatomical landmark 208) for the segmentation model 210. implementing the segmentation model 210. implementing the post-processing module 214, providing the output 212 of the segmentation model 210 to a display 220 or storing the output 212 of the segmentation model 210 in data storage 222. For example, the computer system may include a programmable processor or combination of programmable processors, such as central processing units (CPUs), graphics processing units (GPUs). and the like. In some implementations, the one or more processors of the computer system may be configured to execute instructions stored in a non-transitory computer readable-media. In this regard, the computer system may be any device or system designed to integrate a variety of software, hardware, capabilities, and functionalities. Alternatively, and by way of particular configurations and programming, the computer system may be a special-purpose system or device. For instance, such special purpose system or device may include one or more dedicated processing units or modules that may be configured (e.g., hardwired. or pre-programmed) to carry out steps. in accordance with aspects of the present disclosure

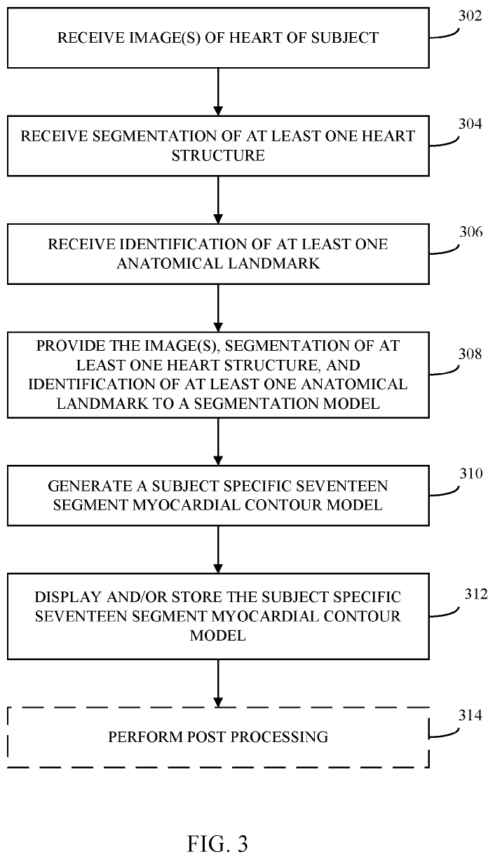

FIG. 3 illustrates a method for segmentation of a cardiac myocardium in one or more images of a subject in accordance with an embodiment. The process illustrated in FIG. 3 is described below as being carried out by the system 200 for segmentation of a cardiac myocardium in one or more images of a subject as illustrated in FIG. 2. Although the blocks of the process are illustrated in a particular order, in some embodiments, one or more blocks may be executed in a different order than illustrated in FIG. 3, or may be bypassed.

At block 302, at least one image of a heart 204 of a subject may be received. The at least one image of the heart 204 of the subject may be. for example. acquired using an imaging modality which has three dimensional information of cardiac anatomy such as, for example, CT. MRI, PET/CT, or SPECT/CT. The images of the heart 204 may be acquired using known imaging systems such as, for example, a CT system or an MRI system, and known acquisition techniques. For example, the received image(s) 204 may be, for example, planning CT images or cardiac late gadolinium enhancement magnetic resonance images. In some embodiments, the at least one image of the heart 204 can be retrieved from data storage (or memory) 216 of system 200, data storage of an imaging system (e.g., a CT system, an MRI system), or data storage of other computer systems (e.g., storage device 1016 of computer system 1000 shown in FIG. 10).

At block 304, a segmentation of at least one heat structure 206 may be received. In some embodiments, the input segmentation of the one or more heart structures 206 (e.g., the left ventricular (LV) structure, the myocardial wall structure) may be automatically generated from images of the heart of a subject (e.g., the images used as an input into the segmentation model for generating the 17-segment myocardial contour model) using a known artificial intelligence (i.e., deep learning neural network(s)) based technique. In some embodiments, the segmentation of the one or more heart structures 206 (e.g., the LV structure, the myocardial wall structure) may be performed manually on images of the heart of the subject (e.g., the images used as an input into the segmentation model for generating the 17-segment myocardial contour model), for example, by a physician. In some embodiments, the segmentation of at least one heat structure 206 can be retrieved from data storage (or memory) 216 of system 200, data storage of an imaging system (e.g., a CT system, an MRI system), or data storage of other computer systems (e.g., storage device 1016 of computer system 1000 shown in FIG. 10).

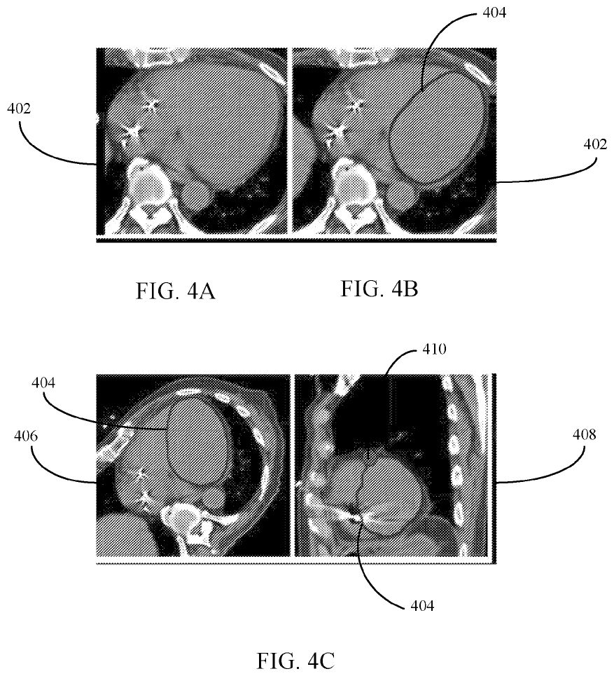

At block 306, at least one anatomical landmark 208 may be received. In some embodiments. the at least one anatomical landmark 208 (e.g., a right ventricle insertion point) may be manually identified by a user (e.g., a physician or operator) on a selected image of the heart of the subject using, for example, a user interface 218 of the system 200. In some embodiments, the user may select one of the images of the heart 204 (e.g., a CT radiation therapy planning image) of the subject and manually identify the one or more anatomical landmarks on the selected image. FIGS. 4A-4C illustrates example inputs for a segmentation model for segmenting a cardiac myocardium in accordance with an embodiment. In the non-limiting example of FIG. 4A, a CT planning image 402 may be selected by the user from, for example, the image(s) 204 (shown in FIG. 2) of the subject. FIG. 4B shows an example LV segmentation or delineation 404 (e.g., the LV myocardium (LVM)) on the selected image 402 of the subject. To identify the anatomical landmark(s), in some embodiments, the image with the LV segmentation 404 may be rotated, for example, axially and sagitally to a double barrel view which is illustrated as image 406 in FIG. 4C. The user (e.g., a physician) may then manually define or identify the anatomical landmark, for example, the right ventricle (RV) insertion point 410 as shown on image 408 in FIG. 4C. The right ventricle insertion point may be defined as where the right ventricle touches the LV. Returning to FIG. 2, in some embodiments, the at least one anatomical landmark 208 can be retrieved from or stored in data storage (or memory) 216 of system 200, data storage of an imaging system (e.g., a CT system, an MRI system), or data storage of other computer systems (e.g., storage device 1016 of computer system 1000 shown in FIG. 10.

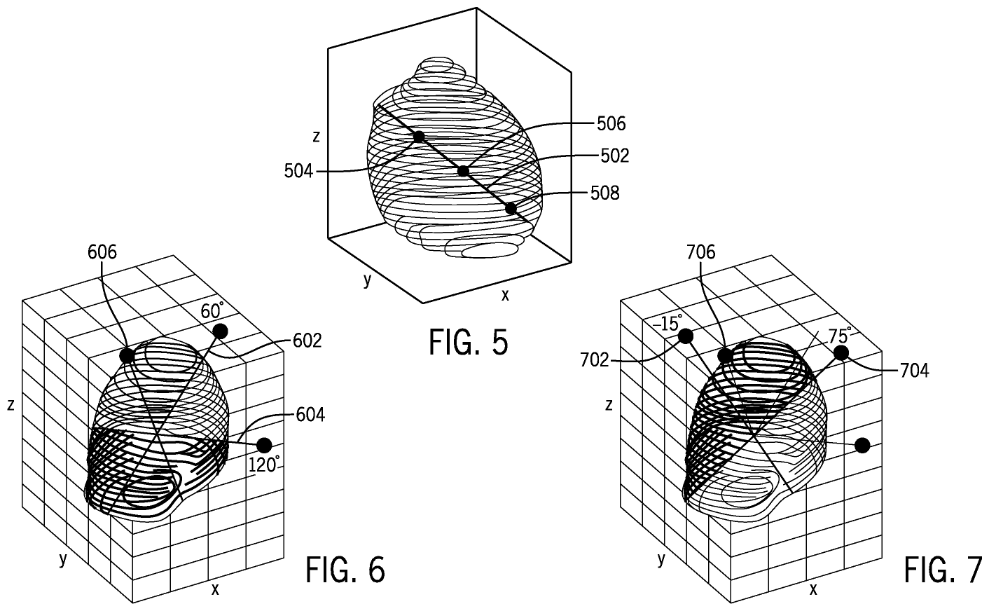

At block 308, the at least one image of the heart 204 of the subject, the segmentation of at least one heart structure 206, and the at least one anatomical landmark 208 may be provided to a segmentation model 210. At block 310, a subject specific seventeen segment contour model may be generated based on the received input 202 received at blocks 302-306 using the segmentation model 210. In some embodiments, to automatically generate the seventeen segments of the myocardial contour 212 (e.g., as defined above for the AHA standard), the segmentation model 210 may first define the axis through the LV that runs the length of its longest portion (i.e., the parasternal long axis (PLAX). In some embodiments, the segmentation model 210 of the present disclosure is configured to automatically generate the parasternal long-axis using principal component analysis (PCA). PCA is a method of ordination designed to simplify and visualize multivariate data. Groups of observations, or data points. can be orthogonally transformed in order to generate a set of linearly uncorrelated eigenmodes. The fixed Euclidian distance between points can be used to determine the new axes for coordinates through Eigen analysis which makes use of the eigenvectors of a matrix. The greatest variability in the dataset can be described by the first eigenvector (i.e. major axis regression). This line of major axis regression is also commonly referred to as the first principal component. PCA assumes a linear relationship between variables (in the case of the systems and methods described herein, x, y, and z coordinates as shown in FIG. 5). FIG. 5 illustrates an example automatically identified parasternal long axis and automatically derived points used to define three parasternal short axis in accordance with an embodiment. As mentioned, the segmentation model 210 (shown in FIG. 2) can be configured to use PCA to define a 1^{st} principal component line 502 that represents the parasternal long axis (PLAX). Then, the segmentation model 210 may be configured to automatically derive and define three points 504, 506, 508 that can be used to define the three parasternal short axes (e.g., the three axes 112, 114, 116 shown in FIG. 1). For example, in some embodiments, the three points used to define the three parasternal short axes may be automatically defined based on the PLAX using geometric definition.

Returning to FIG. 3, once the PLAX is defined (e.g., a first principal component line) and the points for defining the parasternal short axes are derived, the segmentation model 210 may be configured to then locate vectors perpendicular to the PLAX at 60° and 120°, respectively, from the RV insertion point 606. FIG. 6 illustrates example vectors used to identify planes used for basal and mid-cavitary regions of a left ventricle in accordance with an embodiment. FIG. 6 illustrates vectors 602, 604 perpendicular to the PLAX (e.g., PLAX 502 shown in FIGS. 5) at 60° and 120°, respectively, from the RV insertion point 606 (e.g., user identified RV insertion point 410 shown in FIG. 4C. The vectors 602, 604 may be used by the segmentation model to identify the three planes used for the basal and mid-cavitary regions of the LVM. Returning to FIG. 3. in some embodiments. for the apical region. the segmentation model 210 may be configured to then define two points 702 and 704 at −15° and 75°, respectively, perpendicular to the PLAX. FIG. 7 illustrates example points used to identify an apical region of a left ventricle in accordance with an embodiment. In FIG. 7, the two example points 702 and 704 are shown and the RF insertion point is represented by the circle 706.

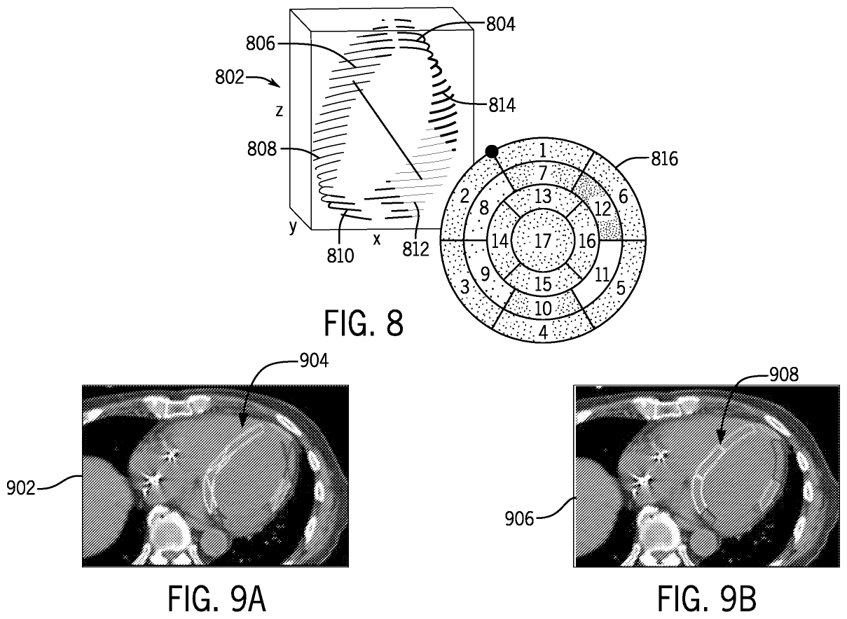

Returning to FIG. 3, the segmentation model 210 may then be configured to combine each of the derived planes to identify regions for each of the 17 cardiac segments. FIG. 8 illustrates an example of identified regions for cardiac segments in accordance with an embodiment. In FIG. 8, the combination 802 of the derived planes can be used to identify regions for the seventeen segments. In FIG. 8, example regions for the seventh segment 804, the eighth segment 806, the ninth segment 808, the tenth segment 810, the eleventh segment 812, and the twelfth segment 814 are shown. In addition. points from the original LV segmentation (e.g., segmentation 206 shown in FIG. 2 and segmentation 404 shown in FIG. 4B) may be assigned to each region. FIG. 8 also shows an example of the points assigned to the mid-cavitary region along with the associated segments on the AHA bullseye diagram 816.

Returning to FIG. 3, in some embodiments, one or more operations of the segmentation model 210 (e.g., as described above) may be implemented using artificial intelligence (i.e., deep learning neural network(s)). For example, a neural network may be configured to perform principal component analysis (PCA) to automatically identify or generate a parasternal long axis (PLAX) for the segmentation process of the segmentation model 210. In some embodiments, a neural network for the segmentation model 210 can be trained using known training methods.

As mentioned above, the segmentation model 210 may be configured to automatically generate a patient specific seventeen segment myocardial contour model 212 at block 310. FIG. 9A shows an example segmentation of a left ventricle including seventeen segments in accordance with an embodiment. The example output 902 in FIG. 9A includes a segmentation 904 of the seventeen segments of the LV generated by the segmentation model 210. At block 312, the subject specific seventeen segment myocardial contour model output 212 generated by the segmentation model 210 may be displayed on a display 220. In some embodiments, the subject specific seventeen segment myocardial contour model output 212 may also be stored in data storage, for example, data storage 222 (e.g., device storage 1016 of computer system 1000 shown in FIG. 10).

At block 314, post-processing (e.g., using post-processing module 214) may be optionally performed on the subject specific seventeen segment myocardial contour model output 212 generated by the segmentation model 210 at block 310. In some embodiments, morphological closing may be used for post-processing after the endocardial and epicardial surfaces of the LV are divided into 17 segments by the segmentation model 210. Morphological closing is a post-processing technique to fuse narrow breaks and eliminate small holes. The process of morphologically closing a segmentation can involve a dilation followed by an erosion with the same structuring element for both operations. In some embodiments, various structure elements may be used for morphological closing post-processing of each of the 17 segments generated by the segmentation model 210. FIG. 9B shows the example segmentation of a left ventricle of FIG. 9A after post processing in accordance with an embodiment. The post-processed output 906 includes a segmentation 908 of the seventeen segments of the LV generated by performing morphological closing on the segmentation 904 shown in FIG. 9A. As the assigned points (shown in FIG. 8) in this example are only on the endocardial and epicardial surfaces, morphological closing may be used to generate a final contours 908 of the 17 segments. The output of the post-processing module 214 may be displayed on a display 220. In some embodiments. the output of the post-processing module 214 may also be stored in data storage, for example, data storage 222 (e.g., device storage 1016 of computer system 1000 shown in FIG. 10.

As mentioned above, in some embodiments, the disclosed system and method provide an automated way to provide the AHA 17-segment model on treatment planning images for radiation therapy planning. The segmentation model described herein can advantageously offer cardiologists and physicians an efficient and precise way to automatically generate segmentations for the 17 segments of the left ventricle on. for example, non-contrast CT images or MRI images. As an aid for radiation therapy planning, the disclosed segmentation model offers significant time saving measures, as well as offers strong potential for widespread application for conducting radio-ablation of the LVM. It is noted that he AHA definitions of the 17 segments may be interpreted differently which will lead to differences in ground truth definitions across entities. In some embodiments, the disclosed segmentation model can advantageously be quickly adapted to easily accommodate a different definition of ground truth.

FIG. 10 is a block diagram of an example computer system in accordance with an embodiment. Computer system 1000 may be used to implement the systems and methods described herein. In some embodiments, the computer system 1000 may be a workstation, a notebook computer, a tablet device, a mobile device, a multimedia device, a network server, a mainframe, one or more controllers, one or more microcontrollers, or any other general-purpose or application-specific computing device. The computer system 1000 may operate autonomously or semi-autonomously, or may read executable software instructions from the memory or storage device 1016 or a computer-readable medium (e.g., a hard drive, a CD-ROM, flash memory), or may receive instructions via the input device 1020 from a user, or any other source logically connected to a computer or device, such as another networked computer or server. Thus, in some embodiments, the computer system 1000 can also include any suitable device for reading computer-readable storage media.

Data. such as data acquired with, for example, an imaging system (e.g., a computed tomography (CT) system, a magnetic resonance imaging (MRI) system, etc.), may be provided to the computer system 1000 from a data storage device 1016, and these data are received in a processing unit 1002. In some embodiments. the processing unit 1002 included one or more processors. For example, the processing unit 1002 may include one or more of a digital signal processor (DSP) 1004, a microprocessor unit (MPU) 1006, and a graphic processing unit (GPU) 1008. The processing unit 1002 also includes a data acquisition unit 1010 that is configured to electronically receive data to be processed. The DSP 1004, MPU 1006. GPU 1008, and data acquisition unit 1010 are all coupled to a communication bus 1012. The communication bus 1012 may be, for example, a group of wires, or a hardware used for switching data between the peripherals or between any component in the processing unit 1002.

The processing unit 1002 may also include a communication port 1014 in electronic communication with other devices, which may include a storage device 1016, a display 1018, and one or more input devices 1020. Examples of an input device 1020 include, but are not limited to, a keyboard, a mouse, and a touch screen through which a user can provide an input. The storage device 1016 may be configured to store data, which may include data such as, for example, images of a subject, LV segmentation(s), identifications of anatomical landmarks, and subject specific seventeen segment myocardial contour models, etc., whether these data are provided to, or processed by, the processing unit 1002. The display 1018 may be used to display images and other information, such as patient health data, and so on.

The processing unit 1002 can also be in electronic communication with a network 1022 to transmit and receive data and other information. The communication port 1014 can also be coupled to the processing unit 1002 through a switched central resource, for example the communication bus 1012. The processing unit 1002 can also include temporary storage 1024 and a display controller 1026. The temporary storage 1024 is configured to store temporary information. For example, the temporary storage 1024 can be a random-access memory.

Computer-executable instructions for automatic segmentation of the cardiac myocardium in image(s) of a subject according to the above-described methods may be stored on a form of computer readable media. Computer readable media includes volatile and nonvolatile, removable, and non-removable media implemented in any method or technology for storage of information such as computer readable instructions, data structures, program modules or other data. Computer readable media includes, but is not limited to, random access memory (RAM), read-only memory (ROM), electrically erasable programmable ROM (EEPROM), flash memory or other memory technology, compact disk ROM (CD-ROM), digital volatile disks (DVD) or other optical storage, magnetic cassettes, magnetic tape, magnetic disk storage or other magnetic storage devices, or any other medium which can be used to store the desired instructions and which may be accessed by a system (e.g., a computer), including by internet or other computer network form of access.

The present invention has been described in terms of one or more preferred embodiments, and it should be appreciated that many equivalents, alternatives, variations, and modifications, aside from those expressly stated, are possible and within the scope of the invention.

1. A method for segmentation of a cardiac myocardium in one or more images of a subject, the method comprising:
receiving at least one image of a heart of the subject, a segmentation of at last one heart structure, and an identification of a right ventricle insertion point:
providing the at least one image of a heart of the subject, the segmentation of the at least one heart structure, and the identification of a right ventricle insertion point to a segmentation model; and
generating, using the segmentation model, a subject specific seventeen segment myocardial contour model.

2. The method according to claim 1, further comprising performing, using a post-processing module. morphological closing on the subject specific seventeen segment contour model.

3. The method according to claim 1, wherein the at least one image of the heart of the subject is one of a computed tomography (CT) image and a magnetic resonance (MR) image.

4. The method according to claim 1, wherein the segmentation model is further configured to identify a parasternal long-axis and a set of points configured to define a plurality of parasternal short-axes.

5. The method according to claim 4, wherein the segmentation model is configured to perform principal component analysis (PCA) to identify the parastemal long-axis.

6. The method according to claim 1, wherein the at least one heart structure is a left ventricle.

7 The method according to claim 1, wherein the at least one heart structure is a myocardium wall.

8 The method according to claim 1, further comprising displaying the subject specific seventeen segment myocardial contour model on a display.

9. The method according to claim 1, wherein the segmentation model is implemented using a neural network.

10. A system for segmentation of a cardiac myocardium in one or more images of a subject, the system comprising:
an input configured to receive at least one image of a heart of the subject, a segmentation of at least one heart structure, and an identification of a right ventricle insertion point; and
a segmentation model coupled to the input and configured to generate a subject specific seventeen segment myocardial contour model based on the at least one image of a heart of the subject, the segmentation of at least one heart structure, and the identification of a right ventricle insertion point.

11. The system according to claim 10 further comprising a post-processing module coupled to the segmentation model and configured to perform morphological closing on the subject specific seventeen segment contour model.

12. The system according to claim 10, wherein the at least one image of the heart of the subject is one of a computed tomography (CT) image and a magnetic resonance (MR) image.

13. The system according to claim 10, wherein the segmentation model is further configured to identify a parasternal long-axis and a set of points configured to define a plurality of parasternal short-axes.

14. The system according to claim 13, wherein the segmentation model is further configured to perform principal component analysis (PCA) to identify the parasternal long-axis.

15. The system according to claim 10, wherein the at least one heart structure is a left ventricle.

16. The system according to claim 10, wherein the at least one heart structure is a myocardium wall.

17. The system according to claim 10, further comprising a display coupled to the segmentation model and configured to display the subject specific seventeen segment myocardial contour model.

18. The method according to claim 10, wherein the segmentation model is implemented using a neural network.
